(19) United States
(12) Patent Application Publication
(10) Pub. No.: US 2007/0013544 A1
(43) Pub. Date: Jan. 18, 2007

(54) Wireless transceiver with multiple independent modulating transmitters

(76) Inventor: Shin-Yung Chiu, Sindian City (TW)

Correspondence Address: BACON & THOMAS, PLLC, 625 SLATERS LANE, FOURTH FLOOR, ALEXANDRIA, VA, 22314, US

(21) Appl. No.: 11/180,623

(22) Filed: Jul. 14, 2005

(51) Int. Cl. B60R 25/00

(52) U.S. Cl. 340/825.69; 340/5.71

(57) ABSTRACT

A wireless transceiver without trainable function to measure carrier frequency from a target remote control device is provided with multiple independent modulating transmitters to successively transmit two or more different output RF with different predetermined carrier frequency but modulating with same signal control code in turn for every time of operating remote control, which comprises a control key unit, a microcontroller unit (MCU), a memory unit, a code-copied unit and a modulating transmitter means with multiple independent modulating transmitters, and in use is capable of saving costs and being widely applicable to remotely control many remote-controlled appliances with same predetermined carrier frequency only by single piece of the invented wireless transceiver.

### BACKGROUND OF THE PRESENT INVENTION

1. Field of the Present Invention

The invention relates to a wireless transceiver, more particularly to a wireless transceiver with multiple independent modulating transmitters to successively transmit two or more different output RF with different predetermined carrier frequency but modulating with same signal control code for every time of operating remote control.

2. Description of Prior Act

Remote control devices, such as those used in the control of garage doors and car alarms, have become an indispensable part of our daily lives. Therefore, there is always a need to make back-up remote control devices in order to avoid replacement of the entire remote control system in the event that a remote control device has been misplaced.

Those prior U.S. Patents including U.S. Pat. Nos. 5,237,319; 5,614,885; 5,614,891; 5,708,415 and 5,854,593 had disclosed a remote control device with learning or trainable function in which a remote control signal transmitted from another remote control device is received to perform learning and to transmit a new remote control signal on the basis of the learning.

Although the trainable remote control device is more convenient in use than one having no learning or trainable function, however, it is more expensive than general remote control device without learning or trainable function, particularly it is a time-consuming tasks for the trainable remote control device to measure carrier frequency from a target remote control device, and the measured carrier frequency is usually happened to out of precision resulted in the trainable remote control device is hardly used in operation of remote control.

### SUMMARY OF THE INVENTION

Therefore, the main object of the present invention is to provide a wireless transceiver without trainable function having multiple independent modulating transmitters to successively transmit two or more different output RF with different predetermined carrier frequency but modulating with same signal control code for every time of operating remote control, which in use is capable of saving costs and being widely applicable to remotely control a garage doors, a car alarms and other remote-controlled appliance simultaneously by single piece of wireless transceiver of the present invention.

Another object of the present invention is to provide a wireless transceiver particularly having two or more independent modulating transmitters with in different combination of predetermined carrier frequency selected from one of 300 MHz, 305 MHz, 310 MHz, 315 MHz, 390 MHz & 433.9 MHz capable of being widely applicable to remotely control many suitable remote-controlled appliances with same predetermined carrier frequency.

Accordingly, the invented wireless transceiver with multiple independent modulating transmitters comprises:
a control key unit including a plurality of control keys;
a memory unit to memorize and store signal control codes that correspond respectively to the control keys;
a code-copied unit comprising a receiver and a demodulator, the receiver is capable of receiving a RF signal transmitted from a target remote-controlled device limited with predetermined identified carrier frequency, and the demodulator is to demodulate the received RF signal to obtain a signal control code;
a microcontroller unit is a programmable microprocessor with I/O pins including functions of receiving the demodulated signal control code output from the code-copied unit and having the demodulated signal control code stored to the memory unit; retrieving corresponding stored signal control code from the memory unit in response to a corresponding control key of the control key unit being pressed; and successively outputting the same retrieved corresponding stored signal control code from two or more I/O pins of the microcontroller unit; and
a modulating transmitter means to successively transmit two or more different output RF is constituted with two or more independent modulating transmitters, each is respectively connected to corresponding I/O pins of the microcontroller unit and provided with a ASK modulator to generate a carrier signal with predetermined different carrier frequency selected from one of 300 MHz, 305 MHz, 310 MHz, 315 MHz, 390 MHz and 433.9 MHz, and to modulate the carrier signal with the same retrieved corresponding stored signal control code output from the microcontroller unit for producing an output RF signal.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic circuit block diagram of the preferred embodiment of a wireless transceiver with multiple independent modulating transmitters to successively transmit RF signals with predetermined carrier frequency of 300 MHz, 310 MHz & 390 MHz according to the present invention for each signal remote-controlled operation;

FIG. 2 is a schematic electrical circuit diagram of the preferred embodiment; and

FIG. 3 is an operated block diagram to illustrate if one of control keys K1-K4 is pressed the wireless transceiver of the present invention shall successively transmit RF signals with predetermined carrier frequency of 300 MHz, 310 MHz & 390 MHz in turn and modulating with same signal control code corresponded to the related control key being pressed.

### DETAILED DESCRIPTION OF THE PREFERRED EMBODIMENTS

Before the present invention is described in greater detail, it should be noted that like elements are denoted by the same reference numerals throughout the disclosure.

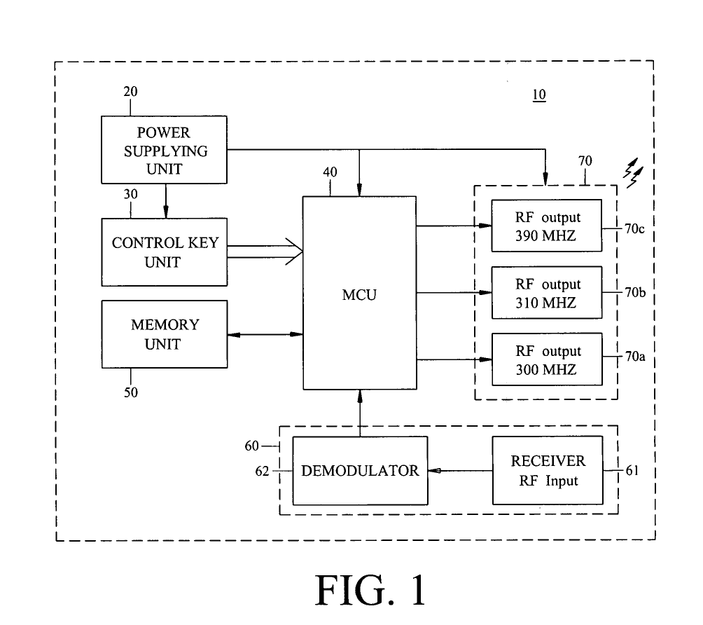

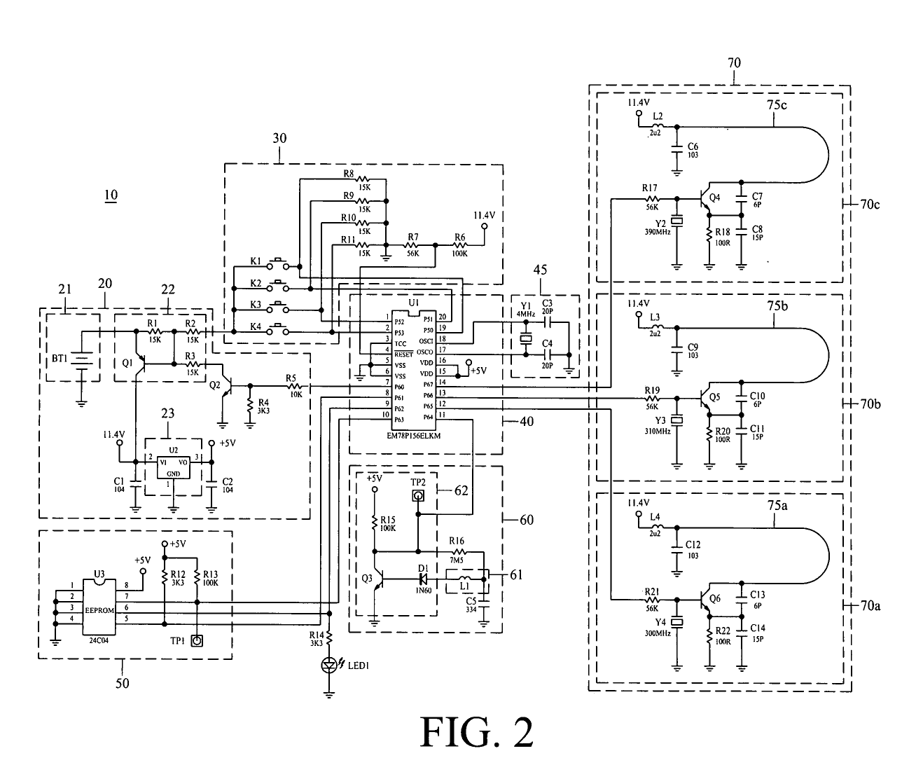

Referring to FIGS. 1 and 2, the preferred embodiment of a wireless transceiver 10 of the present invention is capable of successively transmitting coded RF signals with predetermined carrier frequency of 300 MHz, 310 MHz & 390 MHz in turn for every time of operating the wireless transceiver 10, which is therefore adapted to remotely control those devices with receiver of demodulating a received RF signal by removing the identified carrier frequency of 300 MHz, 310 MHz & 390 MHz from the control code in the received RF signal.

For example, a piece of wireless transceiver 10 of the present invention in use is widely applicable to remotely control a garage doors, a car alarms and other remote-controlled appliance simultaneously.

The wireless transceiver 10 of the present invention comprise a power supplying unit 20, a control key unit 30, a microcontroller unit (MCU) 40, a memory unit 50, a code-copied unit 60 and a modulating transmitter means 70 with multiple independent modulating transmitters.

The power supplying unit 21 is a power source supplied to the wireless transceiver 10, which at least includes a battery 21, a current limiter 22 and a voltage regulator 23. The current limiter 22 includes a transistor Q1 and first and second resistors R1, R2 that are connected in series. The transistor Q1 has an emitter connected to the positive terminal of the battery 21. The negative terminal of the battery 21 is grounded. The first resistor R1 is connected across the emitter and the base of the transistor Q1. The voltage regulator 23 has an input terminal connected to the collector of the transistor Q1.

The control key unit 30 includes a plurality of control keys. In this embodiment, the control key unit 30 includes four control keys K1-K4, each of which has a first switch contact connected to the second resistor R2 of the current limiter 22. When one of the control keys K1-K4 is operated, an electrical signal from the current limiter 22 is asserted at the second switch contact of the control key K1-K4.

The control key unit 30 is used to control the whole operation to the wireless transceiver 10 including operating a copy mode selected to copy a signal control code from a target remote-controlled device, or operating a signal generating mode selected to proceed a remote-controlled operation by successively transmitting a coded RF signals with predetermined carrier frequency of 300 MHz, 310 MHz & 390 MHz in turn.

The microcontroller unit (MCU) 40 is a programmable microprocessor, like an 8-bit CMOS microprocessor of EM78P156ELKM with 20 pins, which receives an operating voltage from an output terminal of the voltage regulator 23. Pin 19, Pin 20, Pin 1 and Pin 2 of the MCU 40 are bi-directional I/O pins, which are respectively connected to the control keys K1-K4 of the control key unit 30.

In operation, the MCU 40 can be coupled with an external oscillator 45 to maintain a stable system frequency, and the MCU 40 is operable in either a copy mode or a signal generating mode. Operation of MCU 40 in the copy mode is initiated when the control keys K1-K4 in a specified combination are operated simultaneously.

The memory unit 25 is connected to Pins 8 to 10 of the MCU 40, and contains memory spaces for storing the signal control code corresponding to each of the control keys K1-K4 of the control key unit 30. For example, an EEPROM may be selectively used as the memory unit 25 for this present invention.

The code-copied unit 60 comprises a receiver 61 and a demodulator 62. The receiver 61 is used to receive a RF signal transmitted from a target remote-controlled device limited with identified carrier frequency of 300 MHz, 310 MHz or 390 MHz, and the demodulator 62 is used to demodulate the received RF signal received by the receiver 61 to obtain a signal control code.

Under operation of the copy mode, Pin 11 of MCU 40 is coupled to the code-copied unit 60, which Pin 11 is a bi-directional I/O used to receive and input the demodulated signal control code output from the code-copied unit 60 by having demodulated a received RF signal transmitted from a target remote-controlled device with identified carrier frequency of 300 MHz, 310 MHz or 390 MHz.

Subsequently, the demodulated signal control code input by Pin 11 of MCU 40 is completely operated in such a way of corresponding to one of the control keys K1-K4 of the control key unit 30, and is output from I/O ports of MCU 40 to memory unit 50 and stored on memory unit 50 for retrieve.

The modulating transmitter means 70 is constituted with two or more independent modulating transmitters 70a, 70b or 70c each of which is provided with a modulator, preferably a ASK modulator, to generate a carrier signal with predetermined different carrier frequency selected from one of 300 MHz, 305 MHz, 310 MHz, 315 MHz, 390 MHz & 433.9 MHz, and to modulate the carrier signal with the stored signal control code mentioned above for producing an output RF signal.

The preferred embodiment of a wireless transceiver 10 of the present invention is selected modulating transmitters 70a with predetermined carrier frequency of 300 MHz, modulating transmitters 70b with predetermined carrier frequency of 310 MHz, and modulating transmitters 70c with predetermined carrier frequency of 390 MHz.

In a word, the modulating transmitters 70a is capable of generating a carrier signal having carrier frequency of 300 MHz and modulating the carrier signal with a stored signal control code memorized on the memory unit 25 to produce a 300 MHz output RF transmitted by an antenna 75a.

Likely, the modulating transmitters 70b is capable of generating a carrier signal having carrier frequency of 310 MHz and modulating the carrier signal with a stored signal control code memorized on the memory unit 25 to produce a 310 MHz output RF transmitted by an antenna 75b; and the modulating transmitters 70c is capable of generating a carrier signal having carrier frequency of 390 MHz and modulating the carrier signal with a stored signal control code memorized on the memory unit 25 to produce a 390 MHz output RF transmitted by an antenna 75c.

Under operation of the signal generating mode, Pins 12 to 14 of MCU 40 are coupled to the modulating transmitter means 70 by respectively connecting each independent modulating transmitters 70a, 70b and 70c to Pins 12 to 14 of MCU 40.

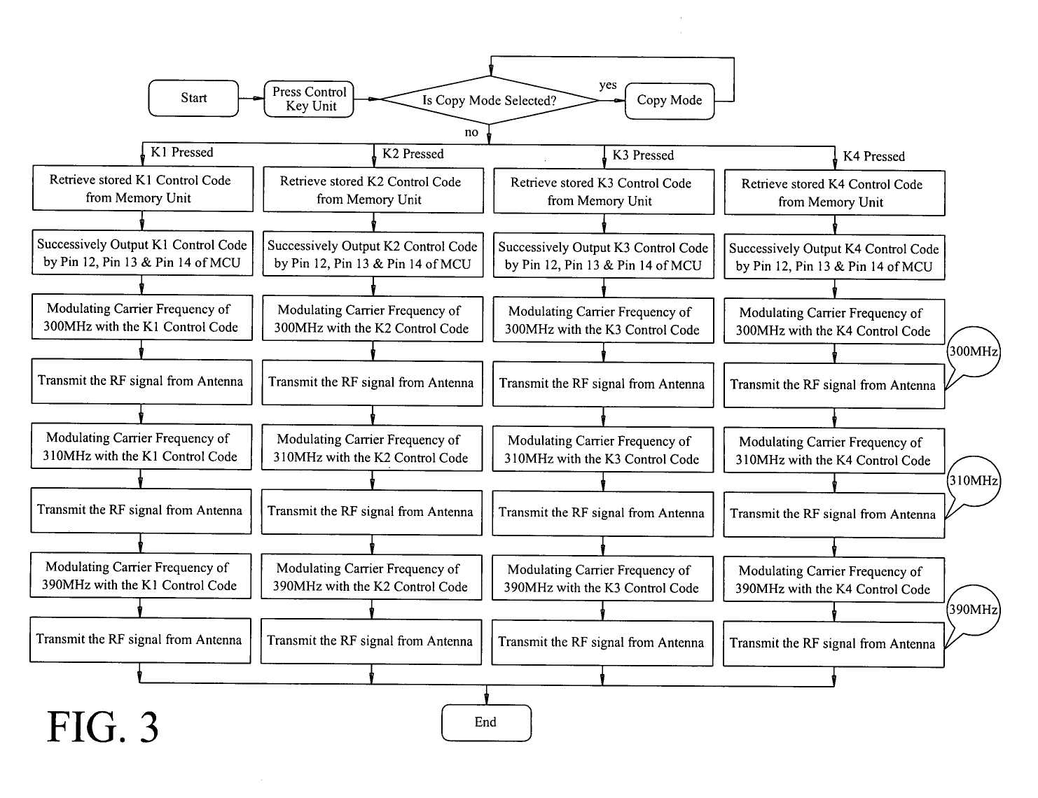

As shown in FIG. 3, in response to one of the control keys K1-K4 of the control key unit 30 being pressed, the MCU 40 shall be operated to retrieve the corresponding stored signal control code relative to the pressed key from the memory unit 25. And, each Pin 12, Pin 13 or Pin 14 are bi-directional I/O of MCU 40 and used to successively output same stored signal control code retrieved from the memory unit 25 to each independent modulating transmitters 70a, 70b and 70c for simultaneously generating a carrier signal having carrier frequency of 300 MHz, 310 MHz & 390 MHz and modulating the carrier signal with same stored signal control code to successively transmit a 300 MHz output RF, a 310 MHz output RF and a 390 MHz output RF in turn.

Taking key K4 being pressed to remotely control a remote-controlled appliance having identified carrier frequency of 300 MHz, 310 MHz or 390 MHz as an example, if a key K4 of the wireless transceiver 10 of the present invention is pressed, the MCU 40 shall retrieve a corresponding stored K4 signal control code relative to the key K4 from the memory unit 25 and successively output the same stored K4 signal control code from I/O ports of MCU 40 to each independent modulating transmitters 70a, 70b and 70c respectively. Thus, the wireless transceiver 10 of the present invention shall during a predetermined period successively transmit a 300 MHz output RF with coded K4 signal control code, a 310 MHz output RF with coded K4 signal control code, and a 390 MHz output RF coded K4 signal control code in turn. Once one of the 300 MHz output RF, 310 MHz output RF or 390 MHz output RF successively transmitted from the wireless transceiver 10 is suitably applied to remotely control the remote-controlled appliance which is then actuated in operation.

Likely, if any one of K1, K2 or K3 of the wireless transceiver 10 of the present invention is pressed, other corresponding remote-controlled appliances shall be remotely controlled to be actuated in operation.

Accordingly, one wireless transceiver 10 of the invention is widely applicable to remotely control many suitable remote-controlled appliances by particularly having two or more independent modulating transmitters 70a, 70b or 70c with in different combination of predetermined carrier frequency selected from one of 300 MHz, 305 MHz, 310 MHz, 315 MHz, 390 MHz & 433.9 MHz.

What is claimed is:

1. A wireless transceiver with multiple independent modulating transmitters capable of successively transmit two or more different output RF with different predetermined carrier frequency but modulating with same signal control code in operating remote control, comprising:
a control key unit including a plurality of control keys;
a memory unit to memorize and store signal control codes that correspond respectively to the control keys;
a code-copied unit comprising a receiver and a demodulator, the receiver is capable of receiving a RF signal transmitted from a target remote-controlled device limited with predetermined identified carrier frequency, and the demodulator is to demodulate the received RF signal to obtain a signal control code;
a microcontroller unit is a programmable microprocessor with I/O pins including functions of receiving the demodulated signal control code output from the code-copied unit and having the demodulated signal control code stored to the memory unit; retrieving corresponding stored signal control code from thee memory unit in response to a corresponding control key of the control key unit being pressed; and successively outputting the same retrieved corresponding stored signal control code from two or more I/O pins of the microcontroller unit; and
a modulating transmitter means to successively transmit two or more different output RF is constituted with two or more independent modulating transmitters, each is respectively connected to corresponding I/O pins of the microcontroller unit and provided with a modulator to generate a carrier signal with predetermined different carrier frequency selected from one of 300 MHz, 305 MHz, 310 MHz, 315 MHz, 390 MHz and 433.9 MHz, and to modulate the carrier signal with the same retrieved corresponding stored signal control code output from the microcontroller unit for producing an output RF signal.

2. The wireless transceiver with multiple independent modulating transmitters as claimed in claim 1, wherein each independent modulating transmitter of the modulating transmitter means with a modulator to generate a carrier signal with predetermined different carrier frequency selected from one of 300 MHz, 310 MHz, and 390 MHz.

3. The wireless transceiver with multiple independent modulating transmitters as claimed in claim 2, wherein the microcontroller unit is an 8-bit CMOS microprocessor of EM78P156ELKM with 20 pins.

4. The wireless transceiver with multiple independent modulating transmitters as claimed in claim 3, wherein the memory unit is EEPROM.

5. The wireless transceiver with multiple independent modulating transmitters as claimed in claim 3, wherein the modulator used on each modulating transmitters of the modulating transmitter means is ASK modulator.

6. The wireless transceiver with multiple independent modulating transmitters as claimed in claim 3, wherein an external oscillator is coupled with the microcontroller unit.

7. The wireless transceiver with multiple independent modulating transmitters as claimed in claim 4, wherein the control key unit includes four keys of K1 to K4.
